(19) United States
(12) Patent Application Publication
(10) Pub. No.: US 2015/0327104 A1
(43) Pub. Date: Nov. 12, 2015

(54) SYSTEMS, METHODS, AND DEVICES FOR CONFIGURING MEASUREMENT GAPS FOR DUAL CONNECTIVITY

(71) Applicants: CANDY YIU, Beaverton, OR (US); YANG TANG, Pleasanton, CA (US); RUI HUANG, Beijing (CN)

(72) Inventors: CANDY YIU, Beaverton, OR (US); YANG TANG, Pleasanton, CA (US); RUI HUANG, Beijing (CN)

(21) Appl. No.: 14/583,283

(22) Filed: Dec. 26, 2014

Related U.S. Application Data
(60) Provisional application No. 61/990,675, filed on May 8, 2014.

(51) Int. Cl. H04W 24/10

(52) U.S. Cl. CPC H04W 24/10

(57) ABSTRACT

Systems and methods for configuring measurement gaps for dual connectivity are disclosed herein. User equipment (UE) may be configured to communicatively couple to a plurality of Evolved Universal Terrestrial Radio Access Network (E-UTRAN) Node Bs (eNBs). For example, the UE may include a plurality of transceivers, and each transceiver may be coupled to a different cell group. A measurement gap may need to be configured for each transceiver. However, the transceivers may interfere with each other's measurement gaps. In an embodiment, a duration of a measurement gap may be increased over a default value to reduce the number of interruptions per measurement gap. Alternatively, or in addition, measurement gaps may begin and/or end at the same. The measurement gaps may have a same repetition period and be aligned each period. Or, the measurement gaps may have different repetition periods and may or may not align periodically.

### RELATED APPLICATIONS

This application claims priority to and the benefit of U.S. Provisional Patent Application No. 61/990,675, filed May 8, 2014, which is hereby incorporated by reference herein in its entirety.

### TECHNICAL FIELD

The present disclosure relates to systems, methods, and devices for configuring measurement gaps for dual connectivity operation of wireless communication device.

### BRIEF DESCRIPTION OF THE DRAWINGS

FIG. 1 is a schematic diagram of a system including a dual-connectivity UE communicatively coupled to a plurality of eNBs.

FIG. 2 is a chart showing the activity of each transceiver of a UE at various frequencies when a measurement length of a measurement gap for one transceiver is increased.

FIG. 3 is a chart showing the activity of each transceiver of a UE at various frequencies when measurement gaps for the transceivers are aligned in time.

FIG. 4 is a chart showing the activity of each transceiver of a UE at various frequencies when different MGRPs are used for each transceiver.

FIG. 5 is a chart showing the activity of each transceiver of a UE at various frequencies when different MGRPs are used for each transceiver but the measurement gaps are aligned in time.

FIG. 6 is a flow diagram of a method for configuring measurement gaps for dual connectivity operation.

FIG. 7 is a schematic diagram of a UE able to receive and process measurement configuration information for configuring dual connectivity measurement gaps.

### DETAILED DESCRIPTION OF PREFERRED EMBODIMENTS

Wireless mobile communication technology uses various standards and protocols to transmit data between a base station and a wireless communication device. Wireless communication system standards and protocols can include, for example, the 3rd Generation Partnership Project (3GPP) long term evolution (LTE); the Institute of Electrical and Electronics Engineers (IEEE) 802.16 standard, which is commonly known to industry groups as worldwide interoperability for microwave access (WiMAX); and the IEEE 802.11 standard, which is commonly known to industry groups as Wi-Fi. In 3GPP radio access networks (RANs) in LTE systems, a base station may include Evolved Universal Terrestrial Radio Access Network (E-UTRAN) Node Bs (also commonly denoted as evolved Node Bs, enhanced Node Bs, eNodeBs, or eNBs) and/or Radio Network Controllers (RNCs) in an E-UTRAN, which communicate with a wireless communication device, known as user equipment (UE). In LTE networks, an E-UTRAN may include a plurality of eNodeBs and may communicate with a plurality of UEs. An evolved packet core (EPC) may communicatively couple the E-UTRAN to an external network, such as the Internet.

LTE networks include radio access technology and core radio network architecture that provide high data rate, low latency, packet optimization, and improved system capacity and coverage. In LTE networks, a UE may communicatively couple with one or more eNBs. A UE may be able to communicatively couple with two or potentially more eNBs at the same time. For example, the UE may include separate transceivers for processing uplink and downlink transmission and receptions. In some embodiments, the transceivers may share one or more components that are not required to be duplicated to transmit and/or receive communications on multiple frequencies. A first communicatively coupled eNB may be part of a master cell group (MCG), and a second communicatively coupled eNB may be part of a secondary cell group (SCG). The UE may perform measurements to determine whether to handover the transceivers to a different frequency, a different cell group, and/or the like (e.g., handover to another SCG while remaining coupled to the MCG, handover to another MCG and dropping of a coupling to the SCG, etc.). However, measurements by one transceiver may be interfered with by the operations of the other transceiver. Similarly, measurements by one transceiver may interfere with the operations of the other transceiver.

Transmission and/or reception may be occurring on one transceiver during a measurement gap for the other transceiver (e.g., when the other transceiver is attempting to perform measurements). Alternatively, or in addition, a transceiver may change frequencies to perform a measurement and interfere with transmission and/or reception by the other transceiver. In some embodiments, an interruption of 5 ms may occur at the start and stop of intra-frequency measurements, and/or an interruption of 1 ms may occur at the start and stop of inter-frequency measurements. For an inter-frequency measurement lasting 6 ms, the 2 ms of interruption may mean that 33% of the measurement time interrupts the other transceiver. In some instances, the changing of frequencies may interfere with the operating transceiver even when the frequencies are far enough apart for the operating transceiver not to interfere with the measuring transceiver.

The E-UTRAN and/or the UE may determine and/or receive a measurement configuration, such as how often measurements should occur (e.g., a measurement gap repetition period (MGRP)), when measurements should occur (e.g., a measurement gap offset, whether measurement gaps should be aligned with one another in time, etc.), a measurement duration (e.g., a measurement gap length), whether each transceiver should have its own measurement gap, and/or the like. The particular measurement configuration may be determined based on transceiver configuration, frequency distance (e.g., intra or inter-frequency, difference in frequencies, etc.), desired amount signaling overhead, desired UE experience, and/or the like.

In an embodiment, the measurement gap length may be increased relative to the measurement gap length used for a single connectivity coupling. For example, the UE may measure signals in multiple frequencies during the longer measurement gap. In addition, the MGRP may be increased. As a result, the ratio of interruption time to measurement time and/or the ratio of interruption time to MGRP may be reduced. The other transceiver may be able to use more subframes for transmitting and/or receiving information. In some embodiments, the increased measurement gap length may be used in combination with the aligning of measurement gaps discussed below.

In an embodiment, the measurement gaps may be aligned in time (e.g., the measurement gaps may begin and/or end at a same point in time). For example, the MGRP and the measurement offset may be the same for both the MCG transceiver and the SCG transceiver. Alternatively, the MCG and SCG may not be in sync, and a different offset may be selected for each to align the measurement gaps. The transceivers may experience no interruption other than what is necessary for their own measurement gaps. In some embodiments, a single set of measurement configuration information may be transmitted to the UE for both transceivers. The E-UTRAN may indicate that the single set of measurement configuration information is for both transceivers, and/or it may be predefined that any measurement configuration information is for both transceivers (e.g., the UE may automatically apply measurement configuration information for one measurement gap to both transceivers). Alternatively, two sets of identical measurement configuration information may be sent to the UE by the E-UTRAN. Alternatively, one set of measurement configuration information may be sent to the UE by the E-UTRAN to apply to both the MCG and SCG transceivers. In other embodiments, the measurement gaps may not be aligned in time, but the amount of misalignment may be selected so that the measurement gaps do not interfere with one another and/or interference is minimized (e.g., a change in frequency for one transceiver's measurement gap does not occur in the middle of a measurement gap for the other transceiver and/or may have MGRPs that are integer multiples of each other).

One transceiver may not need to perform measurements as frequently as the other transceiver. For example, a coverage layer serviced by one transceiver may only have two frequency layers, but the offloading layer serviced by the other transceiver may have four frequency layers. The MCG transceiver may then sacrifice time that could be used for transmitting and/or receiving information to perform measurements that are not needed. In an embodiment, the E-UTRAN may assign different MGRPs to each transceiver. In the previous example, a longer MGRP may be assigned to the MCG transceiver, which has fewer frequency layers, and a shorter MGRP may be assigned to the SCG transceiver. The same measurement gap offset may be used for both transceivers so that the measurements of the transceivers are periodically aligned in time. The transceiver with the longer MGRP may still experience interruptions when it is not performing a measurement but the other transceiver is. However, the transceiver with the longer MGRP may be able transmit and/or receive data during the measurement gap of the other transceiver when the interruptions are not occurring. For example, for a coverage layer that only includes two frequency layers, the transceiver may use one frequency layer and have only one other frequency layer to measure. The transceiver may perform measurements much less often than a transceiver responsible for measuring more than one frequency layer. As a result, power consumption and/or throughput may be improved relative to a configuration requiring identical MGRPs.

In some embodiments, the MGRPs may be limited to values of 40 ms and 80 ms. In other embodiments, there may be additional possible values for the MGRPs. The additional possible values may be limited to integer multiples of possible MGRP values. Alternatively, or in addition, the E-UTRAN may be required to select MGRPs that are integer multiples of each other. A time between overlaps of the MGRPs (e.g., a period) may be the least common multiple of the MGRPs. Thus, restricting the MGRPs to integer multiples of each may ensure a period as small as the larger MGRP. Otherwise, the period may be larger and more interruptions may occur between the two transceivers before the measurement gaps align (e.g., each transceiver may interrupt the other before the alignment occurs). In alternate embodiments, other rules may be used for ensuring the period (e.g., the least common multiple) is as small as possible.

The UE may indicate the capabilities of the transceiver to the E-UTRAN. For example, if one transceiver is only able use a limited set of frequencies, the UE may indicate this to the E-UTRAN. The E-UTRAN may then assign a larger MGRP to the transceiver only capable of using the limited set of frequencies. In an embodiment, capability information for the UE's transceivers may be sent using a radio resource control (RRC) message. The RRC message may be sent while the UE is performing a connection setup with an eNB.

Alternatively, the UE may not indicate its capabilities but rather may transmit indications of preferences to the E-UTRAN. For example, the UE may transmit indications of time values that it would like used for the MGRPs. In another embodiment, the UE may transmit an indication of a desired multiple (e.g., a desired relative sizing) for the transceivers. The E-UTRAN may determine the measurement configuration information based on the indicated capabilities and/or preferences. The E-UTRAN may select measurement configuration information based on the indicated capabilities and/or preferences. The E-UTRAN may select measurement configuration information that is consistent with the indicated capabilities and/or priorities. Alternatively, the E-UTRAN may deviate from the indicated capabilities and/or preferences but may still account for them when determining the measurement configuration information. For example, the E-UTRAN may have information that is not available to the UE. The E-UTRAN may know which frequencies are used by each cell group, so the E-UTRAN may determine the measurement configuration information based on this knowledge and the frequencies it knows or believes are supported by each transceiver.

In an embodiment, the UE may provide feedback to the E-UTRAN about the selected measurement configuration information. The UE may or may not have previously provided indications of capabilities or preferences. For example, the E-UTRAN may configure measurement gaps for both transceivers of the UE. However, the UE may not be able to perform some measurements of some frequencies because of limitations on the capabilities of the transceivers. The UE may indicate to the E-UTRAN that limitations prevent it from performing the measurements and/or may indicate which limitations are limiting it. The E-UTRAN may reconfigure the measurement gaps so to better align the gaps for the transceivers and/or may reassign a new measurement gap based on the capabilities of the UE. Measurement gap configuration information and/or measurement objects may also, or instead, be reconfigured and/or reassigned.

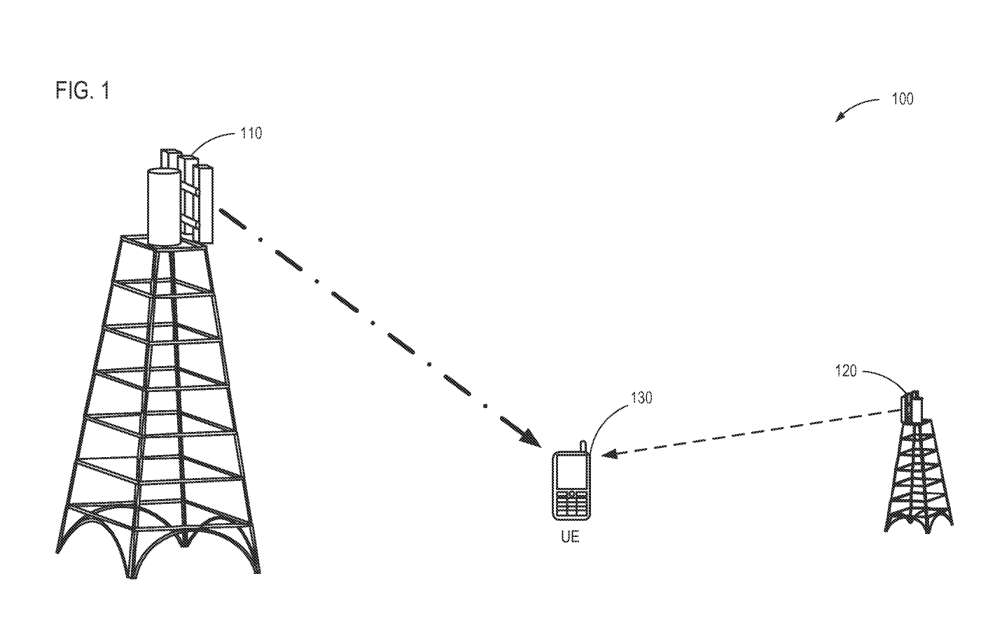

FIG. 1 is a schematic diagram of a system 100 including a dual-connectivity UE 130 communicatively coupled to a plurality of eNBs 110, 120. For example, the UE 130 may be communicatively coupled to a macro eNB 110, which may be part of an MCG. The UE 130 may also be communicatively coupled to a small cell eNB 120 (e.g., a micro cell, a pico cell, a femto cell, etc.), which may be part of an SCG. The UE 130 may include two transceivers for communicating with the two eNBs 110, 120. The UE 130 may need to perform measurements to determine whether either of the transceiver should be handed over to a new eNB. The UE 130 may receive measurement configuration information that indicates duration, length, alignment, etc. for measurement gaps during which the measurements will be performed. The measurement configuration information may be received from each eNB 110, 120 individually for the corresponding transceiver and/or may receive measurement configuration information for both transceivers from a single eNB 110, 120. The UE 130 may perform measurements according to the measurement configuration information received. The measurement configuration information for each transceiver may be select to have a relationship with the measurement configuration information for the other transceiver that optimizes performance of the UE 130 (e.g., power consumption, throughput, etc.).

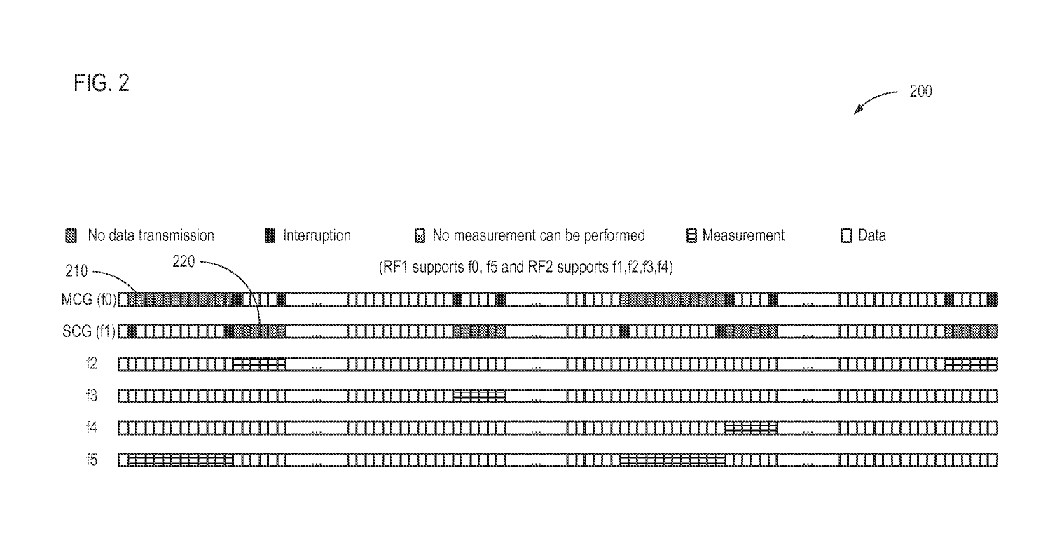

FIG. 2 is a chart 200 showing the activity of each transceiver of a UE at various frequencies when a measurement length of a measurement gap 210 for one transceiver is increased. A first transceiver may be communicatively coupled to an MCG and may support operations and measurements on the frequencies f0 and f5 but not on frequencies f1-f4. A second transceiver may be communicatively coupled to an SCG and may support operations and measurement on frequencies f1-f4. In the illustrated embodiment, a measurement gap length of the measurement gap 210 for the MCG transceiver has been increased relative to the measurement time used by a single connectivity UE while the measurement gap length of the measurement gap 220 for the SCG transceiver has been left unchanged. In other embodiments, the measurement gap length of the measurement gap 220 for the SCG transceiver may be increased also, or instead.

The measurement gaps for the MCG and SCG transceiver 210, 220 may or may not be aligned in time. For example, in an embodiment, other constraints may force the MCG measurement gap 210 to be misaligned with the SCG measurement gap 220. In such an embodiment, increasing the measurement gap length for at least one of the MCG measurement gap 210 and the SCG measurement gap 220 may reduce the ratio of interruption time to measurement time despite the misalignment. In the illustrated embodiment, the increased measurement gap length for the MCG measurement gap 210 may be combined with a longer MGRP. Accordingly, the interruptions of the MCG measurement gap 210 may last the same amount of time but may occur only half as frequently. In alternate embodiments, the MGRP may not be increased with the longer measurement time. In the illustrated embodiment, a single frequency is measured for the entirety of the extended measurement time. In alternate embodiments, multiple frequencies may be measured consecutively during the measurement gap. For example, when measuring two frequencies consecutively, three interruptions for changes in frequency may be required rather than the four interruptions that would be required if the measurements occurred in different measurement gaps from each other. Thus, the ratio of interruption time to measurement time and/or number of measurements may be reduced.

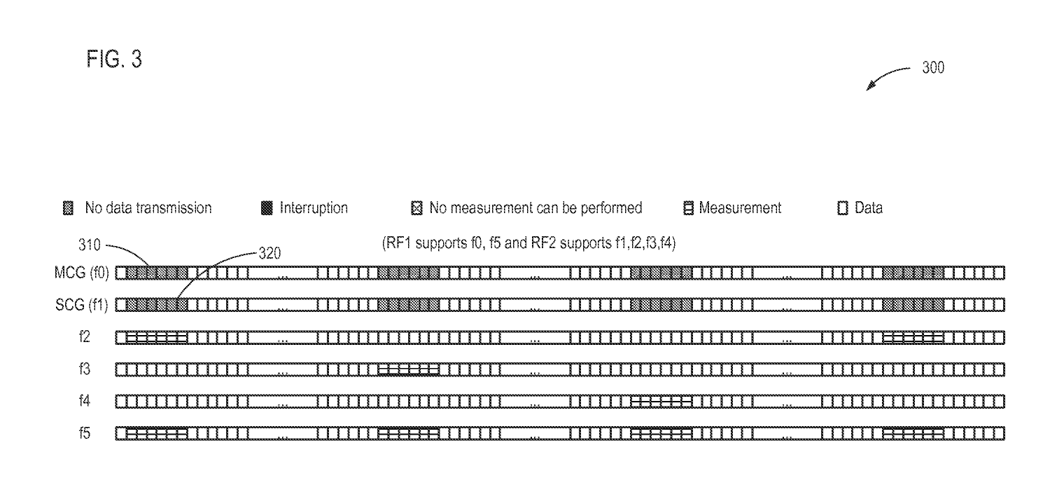

FIG. 3 is a chart 300 showing the activity of each transceiver of a UE at various frequencies when measurement gaps 310, 320 for the transceivers are aligned in time. The MGRPs for the transceivers may be the same as each other. In addition, the measurement offset and/or the measurement length of the measurement gaps 310, 320 may be the same as well. Accordingly, the measurement gaps 310, 320 may begin and end at the same time, and any time a measurement gap 310, 320 occurs for one transceiver, a measurement gap 310, 320 for the other transceiver may occur as well. Time aligned measurement gaps 310, 320 with the same MGRP may be referred to as single aligned measurement gaps.

Because the measurement gaps 310, 320 occur at the same time, there may not be any interruption of each other. Both transceivers may change frequencies at the same time, so any interruption occurs when the transceiver was already interrupting itself. In some embodiments, a single set of measurement configuration information may be used for both transceivers. The UE may be preconfigured to use the received measurement criteria for both transceivers, may use the same measurement criteria if only one set of measurement criteria is received, may receive an indication that the measurement criteria should be used for both transceivers, and/or the like. In some embodiments, the subframes and/or frames of the MCG and the SCG may not be aligned in time, so using the same measurement configuration information may result in misaligned measurement gaps. The E-UTRAN may determine the relative offset between the subframes and/or frames, and the measurement criteria information transmitted by the E-UTRAN may compensate for any offset so that the measurement gaps 310, 320 are aligned.

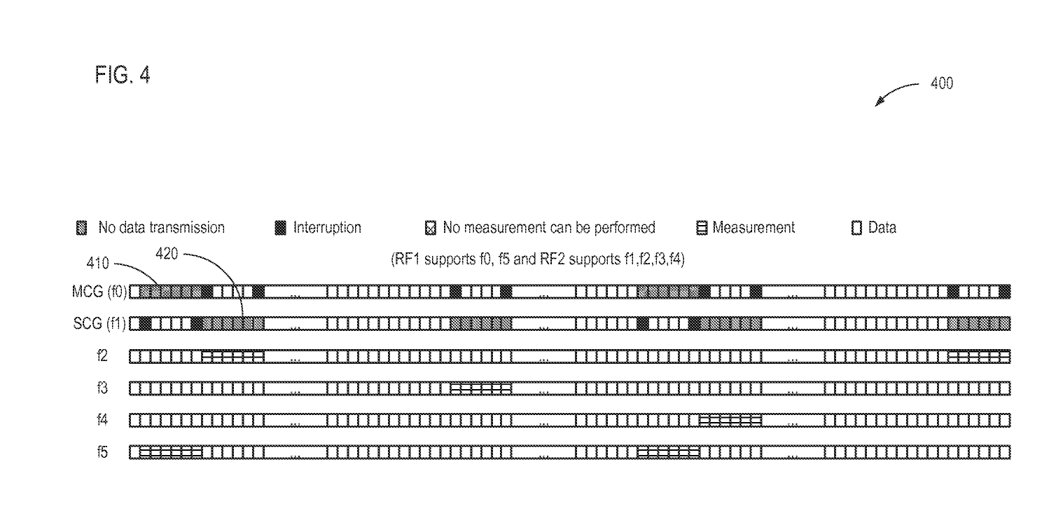

FIG. 4 is a chart 400 showing the activity of each transceiver of a UE at various frequencies when different MGRPs are used for each transceiver. The transceivers of the UE may only be able to operate on or measure certain frequencies. In the illustrated embodiment, a first transceiver, communicatively coupled to the MCG, may only support frequencies f0 and f5 and not frequencies f1-f4. The second transceiver, communicatively coupled to the SCG, may only support frequencies f1-f4 and not frequencies f0 and f5. The first transceiver may be camped on frequency f0, so it may only need to measure frequency f5. In contrast, the second transceiver may be camped on f1 and may need to measure frequencies f2, f3, and f4.

Different MGRPs may be used for each transceiver. The first transceiver may be performing needless measurements if it uses an MGRP optimized for the second transceiver, or the second transceiver may not perform measurements quickly if it uses an MGRP optimized for the first transceiver. Performance for each transceiver may be optimized by select the MGRP most suitable for that transceiver. The first transceiver may have measurement gaps 410 occasionally but may be able to transmit and/or receive additional data when it does not have a measurement gap 410. The second transceiver may have measurement gaps 420 frequently enough to measure all the frequencies being monitored in a timely manner. In a misaligned case, the second transceiver may also have fewer interruptions due to there being fewer measurement gaps 410 for the first transceiver. Additionally, in the misaligned case, the first transceiver may be able to use the entirety of the omitted measurement gap for transmitting and receiving data. Accordingly, performance of the first and second transceivers may be improved.

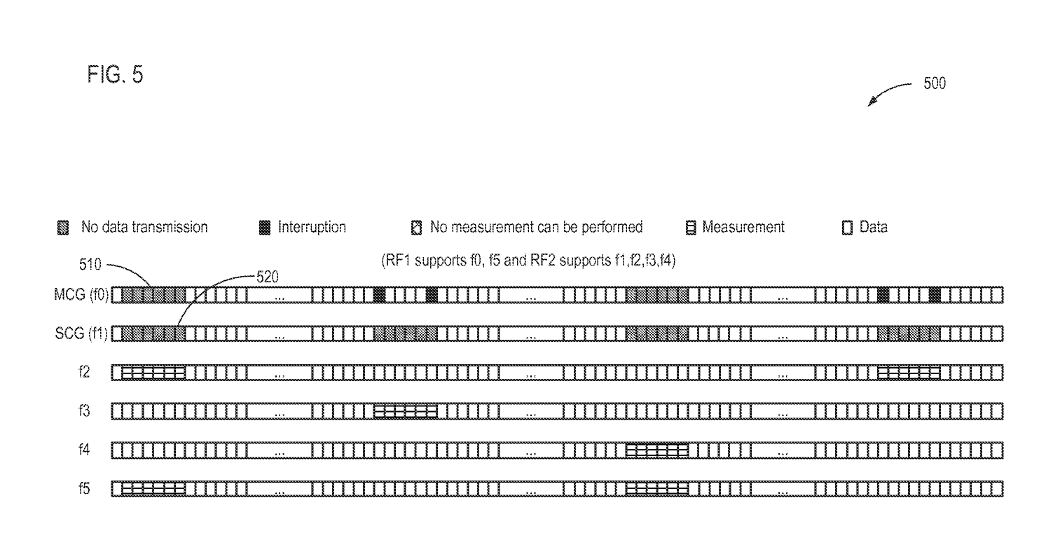

FIG. 5 is a chart 500 showing the activity of each transceiver of a UE at various frequencies when different MGRPs are used for each transceiver but the measurement gaps 510, 520 are aligned in time. Time aligned measurements gaps 510, 520 with different MGRPs for each transceiver may be referred to as multiple aligned measurement gaps. As with the previous embodiment, the MCG transceiver may only support frequencies f0 and f5, and the SCG transceiver may only support frequencies f1-f4. Accordingly, the MGRP for the MCG transceiver may be selected to be larger than the MGRP for the SCG transceiver. Thus, the MCG transceiver is able to transmit and/or receive data at times it may otherwise have been performing measurements that provide little additional benefit to performance, and the SCG transceiver is able to perform measurements frequently enough to perform timely measurements of all the frequencies it is monitoring.

In addition, the measurement gaps 510, 520 may be aligned in time whenever the MCG transceiver has a measurement gap 510. When both the MCG transceiver and the SCG transceiver have measurement gaps 510, 520, the alignment may result in neither measurement gap 510, 520 interrupting the other measurement gap 510, 520. When only the SCG transceiver has a measurement gap 520, interruptions may occur for the MCG transceiver. However, the MCG transceiver may be able to transmit and/or receive additional data between the interruptions that it might not be able to transmit in an embodiment with single aligned measurement gaps. Thus, the MGRPs may be tailored to the requirements of each transceiver, and interruptions may still be minimized to the extent possible.

In the illustrated embodiment, the MGRPs are integer multiples of each other. As a result, the least common multiple of the MGRPs is the larger MGRP, and every time the transceiver with the larger MGRP has a measurement gap, the other transceiver will have one as well. In other embodiments, the MGRPs may not be integer multiples of each other. In such embodiments, both transceivers may have measurement gaps that are not aligned with measurement gaps of the other transceiver. The period between each time the measurement gaps are aligned may be the least common multiple of the MGRPs. In some embodiments, the MGRPs may be selected so that the size of the least common multiple is not too large even if the MGRPs are not integer multiples of each other.

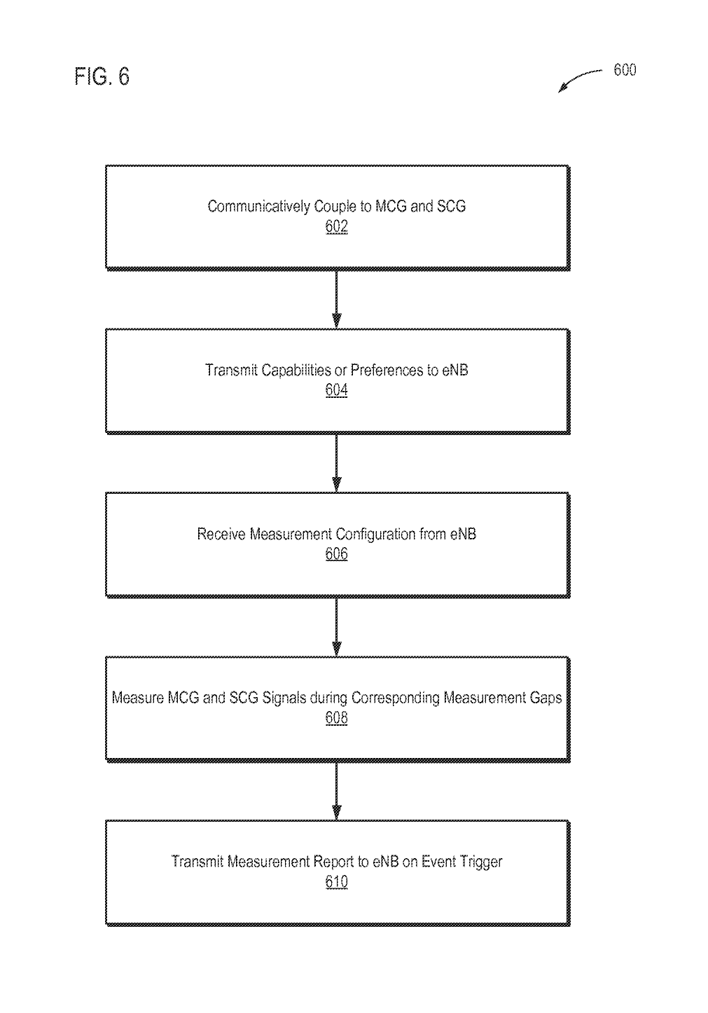

FIG. 6 is a flow diagram of a method 600 for configuring measurement gaps for dual connectivity operation. The method 600 may begin with communicatively coupling 602 to an MCG and an SCG. The MCG and the SCG may be communicatively coupled to at the same time and/or one may be communicatively coupled to sometime after the other. Measurement capabilities and/or measurement preferences may be transmitted 604 to an eNB. The measurement capabilities and/or measurement preferences may be transmitted to an eNB in the MCG, an eNB in the SCG, and/or eNBs in both the MCG and the SCG. The measurement capabilities and/or measurement preferences may be transmitted 604 when the MCG is communicatively coupled to, when the SCG is communicatively coupled to, and/or at a later point in time. In other embodiments, feedback about an already received measurement configuration information may be provided to the MCG and/or SCG rather than providing indications of the measurement capabilities and/or measurement preferences in advance.

The MCG and/or the SCG may use the provided measurement capabilities and/or measurement preferences to determine the measurement configuration information. For example, a longer MGRP may be selected for a transceiver that is only able to monitor a limited number of frequencies. The measurement configuration information may be transmitted by an MCG eNB, an SCG eNB, both, and/or the like (e.g., each cell group may provide measurement configuration information for itself, one cell group may provide measurement configuration information for both cell groups, etc.). The measurement configuration information may then be received 606 from the transmitting eNB(s). The measurement configuration information may include MGRPs, measurement lengths, offsets and/or time of measurements, whether different measurement configuration information and/or MGRPs will be used for each cell group, and/or the like.

Measurement gaps for the MCG and the SCG may be configured based on the received measurement configuration information. A particular measurement to be performed during each measurement gap may be determined. The determined MCG and SCG signals may be measured 608 during the corresponding measurement gaps (e.g., an MCG signal may be measured during a measurement gap for an MCG transceiver and an SCG signal may be measured during a measurement gap for an SCG transceiver). The signal level, signal quality, and/or the like may be measured during the measurement gaps. The measurement parameters may be calculated from the measurements, and a measurement report may be transmitted 610 to an MCG eNB, an SCG eNB, and/or both when one or more trigger events occur. Based on the measurements, the MCG transceiver and/or the SCG transceiver may perform handover to a new cell.

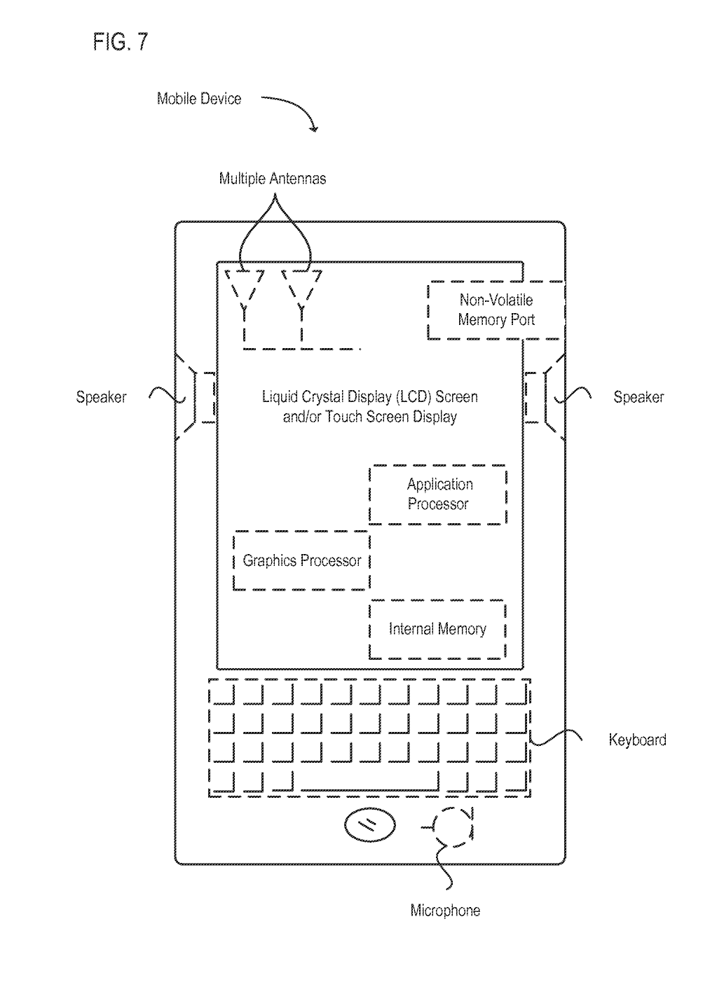

FIG. 7 is an example illustration of a mobile device, such as a UE, a mobile station (MS), a mobile wireless device, a mobile communication device, a tablet, a handset, or another type of wireless communication device. The mobile device can include one or more antennas configured to communicate with a transmission station, such as a base station (BS), an eNB, a base band unit (BBU), a remote radio head (RRH), a remote radio equipment (RRE), a relay station (RS), a radio equipment (RE), or another type of wireless wide area network (WWAN) access point. The mobile device can be configured to communicate using at least one wireless communication standard, including 3GPP LTE, WiMAX, high speed packet access (HSPA), Bluetooth, and Wi-Fi. The mobile device can communicate using separate antennas for each wireless communication standard or shared antennas for multiple wireless communication standards. The mobile device can communicate in a wireless local area network (WLAN), a wireless personal area network (WPAN), and/or a WWAN.

FIG. 7 also provides an illustration of a microphone and one or more speakers that can be used for audio input and output from the mobile device. The display screen may be a liquid crystal display (LCD) screen or other type of display screen, such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

### EXAMPLES

The following examples pertain to further embodiments:

Example 1 is a UE configured to communicate with an E-UTRAN. The UE includes a transceiver coupled to an MCG and coupled to an SCG. The UE also includes a processor coupled to the transceiver. The processor is configured to receive measurement gap configuration information for the MCG and the SCG. The measurement gaps for the MCG indicated by the measurement gap configuration information are aligned in time with measurement gaps for the SCG indicated by the measurement gap configuration information. The processor is also configured to instruct the transceiver to measure MCG and SCG signals during the measurement gaps for the MCG and the SCG.

In Example 2, the measurement gap configuration information of Example 1 indicates a MGRP for the MCG that is equal to a MGRP for the SCG.

In Example 3, the measurement gap configuration information of any of Examples 1-2 includes a single set of configuration parameters for defining the measurement gaps for both the MCG and the SCG.

In Example 4, the measurement gap configuration information of Example 1 indicates a first MGRP for the MCG and a second MGRP for the SCG. The first MGRP is different than the second MGRP.

In Example 5, one of the first MGRP and the second MGRP of Example 4 is an integer multiple of the other of the first MGRP and the second MGRP.

In Example 6, the measurement gap configuration information of any of Examples 1-5 indicates a measurement gap length longer than a gap length used for a single connectivity coupling.

In Example 7, the processor of any of Examples 1-6 is configured to instruct the transceiver to transmit an RRC message indicating transceiver capabilities during connection setup.

In Example 8, the processor of any of Examples 1-7 is configured to receive measurement objects. The processor is also configured to instruct the transceiver to indicate limitations in transceiver capability prevent it from performing measurements indicated by the measurement objects and measurement gap configuration information.

Example 9 is a method for configuring dual connectivity measurement gaps. The method includes determining, using a processor, a wireless communication device is communicatively coupled to a master base station and a secondary base station. The method also includes selecting, using the processor, a measurement gap length and an MGRP for each communicative coupling. The measurement gap length selected for at least one communicative coupling is longer than a measurement gap length for a single connectivity coupling. The method also includes transmitting indications of the measurement gap length and the an MGRP for each communicative coupling to the wireless communication device.

In Example 10, the method of Example 9 also includes selecting a measurement gap offset for each communicative coupling. The measurement gap offsets are selected to align measurement gaps across the communicative couplings.

In Example 11, the MGRPs of Example 10 are selected to be equal to each other.

In Example 12, the MGRPs of Example 10 are selected to be different from each other.

In Example 13, the MGRPs of Example 12 are selected to be integer multiples of each other.

In Example 14, the MGRPs of any of Examples 9-13 are selected based on capability information sent by the wireless communication device during connection setup.

In Example 15, the MGRPs of any of Examples 9-14 are selected based on indications of preferred measurements for each communicative coupling.

In Example 16, the MGRPs of any of Examples 9-15 are selected based on feedback received in response to previously indicated MGRPs.

Example 17 is an apparatus including means to perform a method as described in any of Examples 9-16.

Example 18 is at least one computer-readable storage medium having stored thereon computer-readable instructions, which when executed, implement a method or realize an apparatus as describe in any of preceding example.

Example 19 is a wireless communication device including circuitry. The circuitry is configured to communicatively couple to a first base station and a second base station. The circuitry is also configured to receive, from at least one of the base stations, an indication of measurement gap frequency for each communicative coupling. The measurement gap frequencies are unequal and integer multiples of each other. The circuitry is also configured to measure a signal during a measurement gap for each communicative coupling according to the indicated measurement gap frequencies. The circuitry is also configured to transmit a measurement report to at least one of the base stations.

In Example 20, the measurement gaps of Example 19 are aligned with each other in time.

In Example 21, the circuitry of any of Examples 19-20 is configured to determine a duration of each measurement gap. The duration of at least one of the measurement gaps is longer than a default duration for devices coupled to a single base station.

In Example 22, the circuitry of any of Examples 19-21 is configured to transmit communication capabilities to at least one of the base stations while setting up the coupling.

In Example 23, the circuitry of any of Examples 19-22 is configured to transmit preferences for frequencies to be measured during the measurement gap for the coupling to the first base station and for frequencies to be measured during the measurement gap for the coupling to the second base station.

In Example 24, the circuitry of any of Examples 19-23 is configured to indicate to at least one of the base stations that a measurement cannot be performed. The circuitry is also configured to receive an indication of an updated measurement gap frequency for at least one communicative coupling.

Example 25 is a master eNB configured to communicatively couple to a UE. The eNB includes a transceiver. The eNB also includes a processor coupled to the transceiver. The processor is configured to determine the UE is communicatively coupled to the master eNB and a secondary eNB. The processor is also configured to select a measurement gap length and a MGRP for each communicative coupling. The measurement gap length selected for at least one communicative coupling is longer than a measurement gap length for a single connectivity coupling. The circuitry is also configured to transmit indications of the measurement gap length and the MGRP for each communicative coupling to the UE.

In Example 26, the processor of Example 25 is further configured to select a measurement gap offset for each communicative coupling. The measurement gap offsets are selected to align measurement gaps across the communicative couplings.

In Example 27, the MGRPs of Example 26 are selected to be equal to each other.

In Example 28, the MGRPs of Example 26 are selected to be different from each other.

In Example 29, the MGRPs of Example 28 are selected to be integer multiples of each other.

In Example 30, the MGRPs of any of Examples 25-29 are selected based on capability information sent by the UE during connection setup.

In Example 31, the MGRPs of any of Examples 25-30 are selected based on indications of preferred measurements for each communicative coupling.

In Example 32, the MGRPs of any of Examples 25-31 are selected based on feedback received in response to previously indicated MGRPs.

Example 33 is a method for configuring dual connectivity measurement gaps. The method includes receiving measurement gap configuration information for an MCG and an SCG. Measurement gaps for the MCG indicated by the measurement gap configuration information are aligned in time with measurement gaps for the SCG indicated by the measurement gap configuration information. The method also includes measuring MCG and SCG signals during the measurement gaps for the MCG and the SCG.

In Example 34, the measurement gap configuration information of Example 33 indicates an MGRP for the MCG that is equal to a MGRP for the SCG.

In Example 35, the measurement gap configuration information of any of Examples 33-34 includes a single set of configuration parameters for defining the measurement gaps for both the MCG and the SCG.

In Example 36, the measurement gap configuration information of Example 33 indicates a first MGRP for the MCG and a second MGRP for the SCG. The first MGRP is different than the second MGRP.

In Example 37, one of the first MGRP and the second MGRP of Example 36 is an integer multiple of the other of the first MGRP and the second MGRP.

In Example 38, the measurement gap configuration information of any of Examples 33-37 indicates a measurement gap length longer than a gap length used for a single connectivity coupling.

In Example 39, the method of any of Examples 33-38 also includes transmitting an RRC message indicating transceiver capabilities during connection setup.

In Example 40, the method of any of Examples 33-39 also includes receiving measurement objects. The method also includes indicating limitations in transceiver capability prevent a transceiver from performing measurements indicated by the measurement objects and measurement gap configuration information.

Example 41 is a master base station for configuring dual connectivity measurement gaps. The base station includes circuitry. The circuitry is configured to determine a wireless communication device is communicatively coupled to the master base station and a secondary base station. The circuitry is also configured to select an MGRP for each communicative coupling. The circuitry is also configured to transmit an indication of the MGRP for each communicative coupling to the wireless communication device.

In Example 42, the circuitry of Example 41 is further configured to select a measurement gap offset for each communicative coupling. The measurement gap offsets are selected to align measurement gaps across the communicative couplings.

In Example 43, the MGRPs of Example 42 are selected to be equal to each other.

In Example 44, the MGRPs of Example 42 are selected to be different from each other.

In Example 45, the MGRPs of Example 44 are selected to be integer multiples of each other.

In Example 46, the MGRPs of any of Examples 41-45 are selected based on capability information sent by the wireless communication device during connection setup.

In Example 47, the MGRPs of any of Examples 41-46 are selected based on indications of preferred measurements for each communicative coupling.

In Example 48, the MGRPs of any of Examples 41-47 are selected based on feedback received in response to previously indicated MGRPs.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium, wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the disclosure is not to be limited to the details given herein, but may be modified within the scope and equivalents of the appended claims.

Those having skill in the art will appreciate that many changes may be made to the details of the above-described embodiments without departing from the underlying principles of the disclosure. The scope of the present application should, therefore, be determined only by the following claims.

1. User equipment (UE) configured to communicate with an evolved universal terrestrial radio access network (E-UTRAN), the UE comprising:
a transceiver coupled to a master cell group (MCG) and coupled to a secondary cell group (SCG); and
a processor coupled to the transceiver, the processor configured to:
receive measurement gap configuration information for the MCG and the SCG, wherein measurement gaps for the MCG indicated by the measurement gap configuration information are aligned in time with measurement gaps for the SCG indicated by the measurement gap configuration information; and
instruct the transceiver to measure MCG and SCG signals during the measurement gaps for the MCG and the SCG.

2. The UE of claim 1, wherein the measurement gap configuration information indicates a measurement gap repetition period (MGRP) for the MCG that is equal to a MGRP for the SCG.

3. The UE of claim 1, wherein the measurement gap configuration information includes a single set of configuration parameters for defining the measurement gaps for both the MCG and the SCG.

4. The UE of claim 1, wherein the measurement gap configuration information indicates a first measurement gap repetition period (MGRP) for the MCG and a second MGRP for the SCG, and wherein the first MGRP is different than the second MGRP.

5. The UE of claim 4, wherein one of the first MGRP and the second MGRP is an integer multiple of the other of the first MGRP and the second MGRP.

6. The UE of claim 1, wherein the measurement gap configuration information indicates a measurement gap length longer than a gap length used for a single connectivity coupling.

7. The UE of claim 1, wherein the processor is configured to instruct the transceiver to transmit a Radio Resource Control (RRC) message indicating transceiver capabilities during connection setup.

8. The UE of claim 1, wherein the processor is configured to receive measurement objects, and instruct the transceiver to indicate limitations in transceiver capability prevent it from performing measurements indicated by the measurement objects and measurement gap configuration information.

9. A method for configuring dual connectivity measurement gaps, the method comprising:
determining, using a processor, a wireless communication device is communicatively coupled to a master base station and a secondary base station;
selecting, using the processor, a measurement gap length and a measurement gap repetition period for each communicative coupling, wherein the measurement gap length selected for at least one communicative coupling is longer than a measurement gap length for a single connectivity coupling; and
transmitting indications of the measurement gap length and the measurement gap repetition period for each communicative coupling to the wireless communication device.

10. The method of claim 9, further comprising selecting a measurement gap offset for each communicative coupling, wherein the measurement gap offsets are selected to align measurement gaps across the communicative couplings.

11. The method of claim 10, wherein the measurement gap repetition periods are selected to be equal to each other.

12. The method of claim 10, wherein the measurement gap repetition periods are selected to be different from each other.

13. The method of claim 12, wherein the measurement gap repetition periods are selected be integer multiples of each other.

14. The method of claim 9, wherein the measurement gap repetition periods are selected based on capability information sent by the wireless communication device during connection setup.

15. The method of claim 9, wherein the measurement gap repetition periods are selected based on indications of preferred measurements for each communicative coupling.

16. The method of claim 9, wherein the measurement gap repetition periods are selected based on feedback received in response to previously indicated measurement gap repetition periods.

17. A wireless communication device comprising:
circuitry configured to:
communicatively couple to a first base station and a second base station;
receive, from at least one of the base stations, an indication of measurement gap frequency for each communicative coupling, wherein the measurement gap frequencies are unequal and integer multiples of each other;
measure a signal during a measurement gap for each communicative coupling according to the indicated measurement gap frequencies; and
transmit a measurement report to at least one of the base stations.

18. The device of claim 17, wherein the measurement gaps are aligned with each other in time.

19. The device of claim 17, wherein the circuitry is configured to determine a duration of each measurement gap, and wherein the duration of at least one of the measurement gaps is longer than a default duration for devices coupled to a single base station.

20. The device of claim 17, wherein the circuitry is configured to transmit communication capabilities to at least one of the base stations while setting up the coupling.

21. The device of claim 17, wherein the circuitry is configured to transmit preferences for frequencies to be measured during the measurement gap for the coupling to the first base station and for frequencies to be measured during the measurement gap for the coupling to the second base station.

22. The device of claim 17, wherein the circuitry is configured to:
indicate to at least one of the base stations that a measurement cannot be performed, and
receive an indication of an updated measurement gap frequency for at least one communicative coupling.
